(19) United States
(12) Patent Application Publication
(10) Pub. No.: US 2021/0003748 A1
(43) Pub. Date: Jan. 7, 2021

(54) CAMERA MODULES COMPRISING LIQUID LENSES AND HEATING DEVICES

(71) Applicant: CORNING INCORPORATED, CORNING, NY (US)

(72) Inventors: David Francis Dawson-Elli, Charlotte, NC (US); Raymond Miller Karam, Santa Barbara, CA (US); Joseph Marshall Kunick, Victor, NY (US)

(21) Appl. No.: 16/977,741

(22) PCT Filed: Mar. 8, 2019
(86) PCT No.: PCT/US2019/021250

§ 371 Date: Sep. 2, 2020

Related U.S. Application Data
(60) Provisional application No. 62/641,046, filed on Mar. 9, 2018.
(60) Provisional application No. 62/646,301, filed on Mar. 21, 2018.
(60) Provisional application No. 62/672,488, filed on May 16, 2018.

(51) Int. Cl. G02B 3/14; G02B 7/02; G02B 26/00

(52) U.S. Cl. CPC G02B 3/14; G02B 7/09; G02B 26/005; G02B 7/028

(57) ABSTRACT

A liquid lens system includes a liquid lens and a heating device disposed in, on, or near the liquid lens. The liquid lens system can include a temperature sensor. The heating device can be responsive to a temperature signal generated by the temperature sensor. A camera module can include the liquid lens system. A method of operating a liquid lens includes detecting a temperature of the liquid lens and heating the liquid lens in response to the detected temperature.

### CROSS REFERENCE TO RELATED APPLICATIONS

This application claims the benefit of priority under 35 U.S.C. § 119 to U.S. Provisional Application Nos. 62/641,046, filed Mar. 9, 2018, 62/646,301, filed Mar. 21, 2018, and 62/672,488, filed May 16, 2018, the content of each of which is incorporated herein by reference in its entirety.

### BACKGROUND

### Field

This disclosure relates to liquid lenses and camera modules comprising liquid lenses.

### Technical Background

Liquid lenses generally include two immiscible liquids disposed within a chamber. Varying the electric field to which the liquids are subjected can vary the wettability of one of the liquids with respect to the chamber wall, thereby varying the shape of the meniscus formed between the two liquids.

### SUMMARY

Disclosed herein are liquid lens systems comprising heating devices and camera modules comprising liquid lenses and heating devices.

Disclosed herein is a liquid lens system comprising a liquid lens and a heating device disposed in, on, or near the liquid lens.

Disclosed herein is a camera module comprising the liquid lens system.

Disclosed herein is a method of operating a liquid lens. A temperature of the liquid lens is detected. The liquid lens is heated in response to the detected temperature.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 is a schematic cross-sectional view of some embodiments of a liquid lens.

FIG. 2 is a schematic front view of the liquid lens of FIG. 1 looking through a first outer layer of the liquid lens.

FIG. 3 is a schematic rear view of the liquid lens of FIG. 1 looking through a second outer layer of the liquid lens.

FIG. 4 is a schematic cross-sectional view of some embodiments of a camera module comprising a liquid lens.

FIG. 5 is a block diagram of some embodiments of a camera module system.

FIG. 6 is a perspective view of an example embodiment of a liquid lens.

FIG. 7 is an exploded view of an example embodiment of a liquid lens.

FIG. 8 is front view of an example embodiment of a liquid lens.

FIG. 9 is a front view of example embodiment of a liquid lens with the first window omitted from view.

FIG. 10 is a partial cross-sectional view of an example embodiment of a liquid lens.

FIG. 11 is a partial cross-sectional view of an example embodiment of a liquid lens.

FIG. 12 is a perspective view of an example embodiment of a liquid lens.

FIG. 13 is a front view of an example embodiment of a liquid lens.

FIG. 14 is a front view of an example embodiment of a liquid lens.

FIG. 15 comprises a front view of an example embodiment of a liquid lens with the first outside layer omitted from view.

FIG. 16 is a partial cross-sectional view showing another example embodiment of a liquid lens.

FIG. 17, is a plot showing the temperature in a liquid lens rising as heat is applied.

FIG. 18 is a plot showing wavefront error measurements for an example embodiment of a liquid lens at different temperatures.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

In various embodiments, a camera module comprises a liquid lens and a heating device. In some embodiments, the camera module comprises a temperature sensor. Additionally, or alternatively, the heating device is controlled in response to a temperature signal generated by the temperature sensor.

In various embodiments, a method of operating a liquid lens comprises heating the liquid lens. For example, heating the liquid lens comprises heating the liquid lens in response to a temperature of the liquid lens. Additionally, or alternatively, heating the liquid lens comprises controlling the temperature of the liquid lens.

Heating a liquid lens as described herein can enable improved speed and/or image quality of the liquid lens and/or a camera module comprising the liquid lens. Without wishing to be bound by any theory, it is believed that increasing the temperature of the liquids within the liquid lens reduces the viscosity of the liquids, thereby enabling the improved speed and/or image quality.

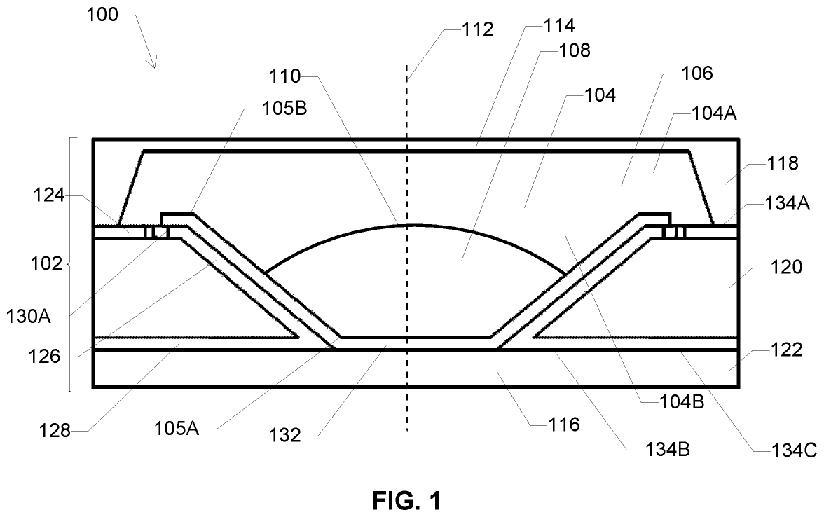

FIG. 1 is a schematic cross-sectional view of some embodiments of a liquid lens 100. In some embodiments, liquid lens 100 comprises a lens body 102 and a cavity 104 formed in the lens body. A first liquid 106 and a second liquid 108 are disposed within cavity 104. In some embodiments, first liquid 106 is a polar liquid or a conducting liquid. Additionally, or alternatively, second liquid 108 is a non-polar liquid or an insulating liquid. In some embodiments, first liquid 106 and second liquid 108 are substantially immiscible with each other and have different refractive indices such that an interface 110 between the first liquid and the second liquid forms a lens. In some embodiments, first liquid 106 and second liquid 108 have substantially the same density, which can help to avoid changes in the shape of interface 110 as a result of changing the physical orientation of liquid lens 100 (e.g., as a result of gravitational forces).

In some embodiments, cavity 104 comprises a first portion, or headspace, 104A and a second portion, or base portion, 104B. For example, second portion 104B of cavity 104 is defined by a bore in an intermediate layer of liquid lens 100 as described herein. Additionally, or alternatively, first portion 104A of cavity 104 is defined by a recess in a first outer layer of liquid lens 100 and/or disposed outside of the bore in the intermediate layer as described herein. In some embodiments, at least a portion of first liquid 106 is disposed in first portion 104A of cavity 104. Additionally, or alternatively, at least a portion of second liquid 108 is disposed within second portion 1046 of cavity 104. For example, substantially all or a portion of second liquid 108 is disposed within second portion 104B of cavity 104. In some embodiments, the perimeter of interface 110 (e.g., the edge of the interface in contact with the sidewall of the cavity) is disposed within second portion 1046 of cavity 104.

Interface 110 can be adjusted via electrowetting. For example, a voltage can be applied between first liquid 106 and a surface of cavity 104 (e.g., an electrode positioned near the surface of the cavity and insulated from the first liquid as described herein) to increase or decrease the wettability of the surface of the cavity with respect to the first liquid and change the shape of interface 110. In some embodiments, adjusting interface 110 changes the shape of the interface, which changes the focal length or focus of liquid lens 100. For example, such a change of focal length can enable liquid lens 100 to perform an autofocus function. Additionally, or alternatively, adjusting interface 110 tilts the interface relative to an optical axis 112 of liquid lens 100. For example, such tilting can enable liquid lens 100 to perform an optical image stabilization (01S) function. Adjusting interface 110 can be achieved without physical movement of liquid lens 100 relative to an image sensor, a fixed lens or lens stack, a housing, or other components of a camera module in which the liquid lens can be incorporated.

In some embodiments, lens body 102 of liquid lens 100 comprises a first window 114 and a second window 116. In some of such embodiments, cavity 104 is disposed between first window 114 and second window 116. In some embodiments, lens body 102 comprises a plurality of layers that cooperatively form the lens body. For example, in the embodiments shown in FIG. 1, lens body 102 comprises a first outer layer 118, an intermediate layer 120, and a second outer layer 122. In some of such embodiments, intermediate layer 120 comprises a bore formed therethrough. First outer layer 118 can be bonded to one side (e.g., the object side) of intermediate layer 120. For example, first outer layer 118 is bonded to intermediate layer 120 at a bond 134A. Bond 134A can be an adhesive bond, a laser bond (e.g., a laser weld), or another suitable bond capable of maintaining first liquid 106 and second liquid 108 within cavity 104. Additionally, or alternatively, second outer layer 122 can be bonded to the other side (e.g., the image side) of intermediate layer 120. For example, second outer layer 122 is bonded to intermediate layer 120 at a bond 134B and/or a bond 134C, each of which can be configured as described herein with respect to bond 134A. In some embodiments, intermediate layer 120 is disposed between first outer layer 118 and second outer layer 122, the bore in the intermediate layer is covered on opposing sides by the first outer layer and the second outer layer, and at least a portion of cavity 104 is defined within the bore. Thus, a portion of first outer layer 118 covering cavity 104 serves as first window 114, and a portion of second outer layer 122 covering the cavity serves as second window 116.

In some embodiments, cavity 104 comprises first portion 104A and second portion 104B. For example, in the embodiments shown in FIG. 1, second portion 104B of cavity 104 is defined by the bore in intermediate layer 120, and first portion 104A of the cavity is disposed between the second portion of the cavity and first window 114. In some embodiments, first outer layer 118 comprises a recess as shown in FIG. 1, and first portion 104A of cavity 104 is disposed within the recess in the first outer layer. Thus, first portion 104A of cavity 104 is disposed outside of the bore in intermediate layer 120.

In some embodiments, cavity 104 (e.g., second portion 104B of the cavity) is tapered as shown in FIG. 1 such that a cross-sectional area of the cavity decreases along optical axis 112 in a direction from the object side to the image side. For example, second portion 104B of cavity 104 comprises a narrow end 105A and a wide end 105B. The terms “narrow” and “wide” are relative terms, meaning the narrow end is narrower, or has a smaller width or diameter, than the wide end. Such a tapered cavity can help to maintain alignment of interface 110 between first liquid 106 and second liquid 108 along optical axis 112. In other embodiments, the cavity is tapered such that the cross-sectional area of the cavity increases along the optical axis in the direction from the object side to the image side or non-tapered such that the cross-sectional area of the cavity remains substantially constant along the optical axis.

In some embodiments, image light enters liquid lens 100 through first window 114, is refracted at interface 110 between first liquid 106 and second liquid 108, and exits the liquid lens through second window 116. In some embodiments, first outer layer 118 and/or second outer layer 122 comprise a sufficient transparency to enable passage of the image light. For example, first outer layer 118 and/or second outer layer 122 comprise a polymeric, glass, ceramic, or glass-ceramic material. In some embodiments, outer surfaces of first outer layer 118 and/or second outer layer 122 are substantially planar. Thus, even though liquid lens 100 can function as a lens (e.g., by refracting image light passing through interface 110), outer surfaces of the liquid lens can be flat as opposed to being curved like the outer surfaces of a fixed lens. In other embodiments, outer surfaces of the first outer layer and/or the second outer layer are curved (e.g., concave or convex). Thus, the liquid lens comprises an integrated fixed lens. In some embodiments, intermediate layer 120 comprises a metallic, polymeric, glass, ceramic, or glass-ceramic material. Because image light can pass through the bore in intermediate layer 120, the intermediate layer may or may not be transparent.

Although lens body 102 of liquid lens 100 is described as comprising first outer layer 118, intermediate layer 120, and second outer layer 122, other embodiments are included in this disclosure. For example, in some other embodiments, one or more of the layers is omitted. For example, the bore in the intermediate layer can be configured as a blind hole that does not extend entirely through the intermediate layer, and the second outer layer can be omitted. Although first portion 104A of cavity 104 is described herein as being disposed within the recess in first outer layer 118, other embodiments are included in this disclosure. For example, in some other embodiments, the recess is omitted, and the first portion of the cavity is disposed within the bore in the intermediate layer. Thus, the first portion of the cavity is an upper portion of the bore, and the second portion of the cavity is a lower portion of the bore. In some other embodiments, the first portion of the cavity is disposed partially within the bore in the intermediate layer and partially outside the bore.

In some embodiments, liquid lens 100 comprises a common electrode 124 in electrical communication with first liquid 106. Additionally, or alternatively, liquid lens 100 comprises a driving electrode 126 disposed on a sidewall of cavity 104 and insulated from first liquid 106 and second liquid 108. Different voltages can be supplied to common electrode 124 and driving electrode 126 to change the shape of interface 110 as described herein.

In some embodiments, liquid lens 100 comprises a conductive layer 128 at least a portion of which is disposed within cavity 104. For example, conductive layer 128 comprises a conductive coating applied to intermediate layer 120 prior to bonding first outer layer 118 and/or second outer layer 122 to the intermediate layer. Conductive layer 128 can comprise a metallic material, a conductive polymer material, another suitable conductive material, or a combination thereof. Additionally, or alternatively, conductive layer 128 can comprise a single layer or a plurality of layers, some or all of which can be conductive. In some embodiments, conductive layer 128 defines common electrode 124 and/or driving electrode 126. For example, conductive layer 128 can be applied to substantially the entire outer surface of intermediate layer 118 prior to bonding first outer layer 118 and/or second outer layer 122 to the intermediate layer. Following application of conductive layer 128 to intermediate layer 118, the conductive layer can be segmented into various conductive elements (e.g., common electrode 124, driving electrode 126, a heating device, a temperature sensor, and/or other electrical devices). In some embodiments, liquid lens 100 comprises a scribe 130A in conductive layer 128 to isolate (e.g., electrically isolate) common electrode 124 and driving electrode 126 from each other. In some embodiments, scribe 130A comprises a gap in conductive layer 128. For example, scribe 130A is a gap with a width of about 5 μm, about 10 μm, about 15 μm, about 20 μm, about 25 μm, about 30 μm, about 35 μm, about 40 μm, about 45 μm, about 50 μm, or any ranges defined by the listed values.

In some embodiments, liquid lens 100 comprises an insulating layer 132 disposed within cavity 104. For example, insulating layer 132 comprises an insulating coating applied to intermediate layer 120 prior to bonding first outer layer 118 and/or second outer layer 122 to the intermediate layer. In some embodiments, insulating layer 132 comprises an insulating coating applied to conductive layer 128 and second window 116 after bonding second outer layer 122 to intermediate layer 120 and prior to bonding first outer layer 118 to the intermediate layer. Thus, insulating layer 132 covers at least a portion of conductive layer 128 within cavity 104 and second window 116. In some embodiments, insulating layer 132 can be sufficiently transparent to enable passage of image light through second window 116 as described herein. Insulating layer 132 can comprise polytetrafluoroethylene (PTFE), parylene, another suitable polymeric or non-polymeric insulating material, or a combination thereof. Additionally, or alternatively, insulating layer 132 comprises a hydrophobic material. Additionally, or alternatively, insulating layer 132 can comprise a single layer or a plurality of layers, some or all of which can be insulating. In some embodiments, insulating layer 132 covers at least a portion of driving electrode 126 (e.g., the portion of the driving electrode disposed within cavity 104) to insulate first liquid 106 and second liquid 108 from the driving electrode. Additionally, or alternatively, at least a portion of common electrode 124 disposed within cavity 104 is uncovered by insulating layer 132. Thus, common electrode 124 can be in electrical communication with first liquid 106 as described herein. In some embodiments, insulating layer 132 comprises a hydrophobic surface layer of second portion 104B of cavity 104. Such a hydrophobic surface layer can help to maintain second liquid 108 within second portion 104B of cavity 104 (e.g., by attraction between the non-polar second liquid and the hydrophobic material) and/or enable the perimeter of interface 110 to move along the hydrophobic surface layer (e.g., by electrowetting) to change the shape of the interface as described herein.

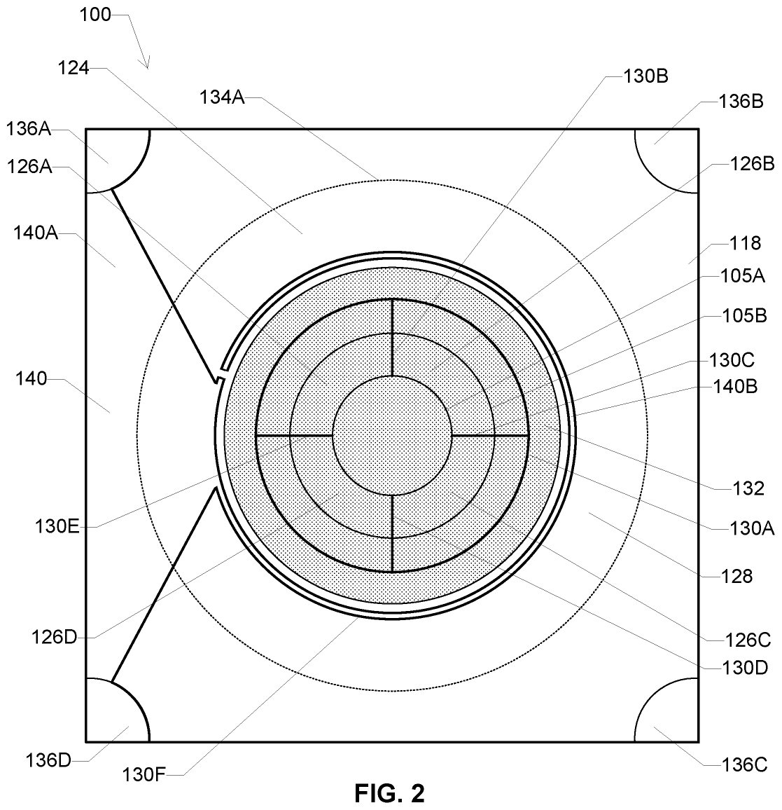

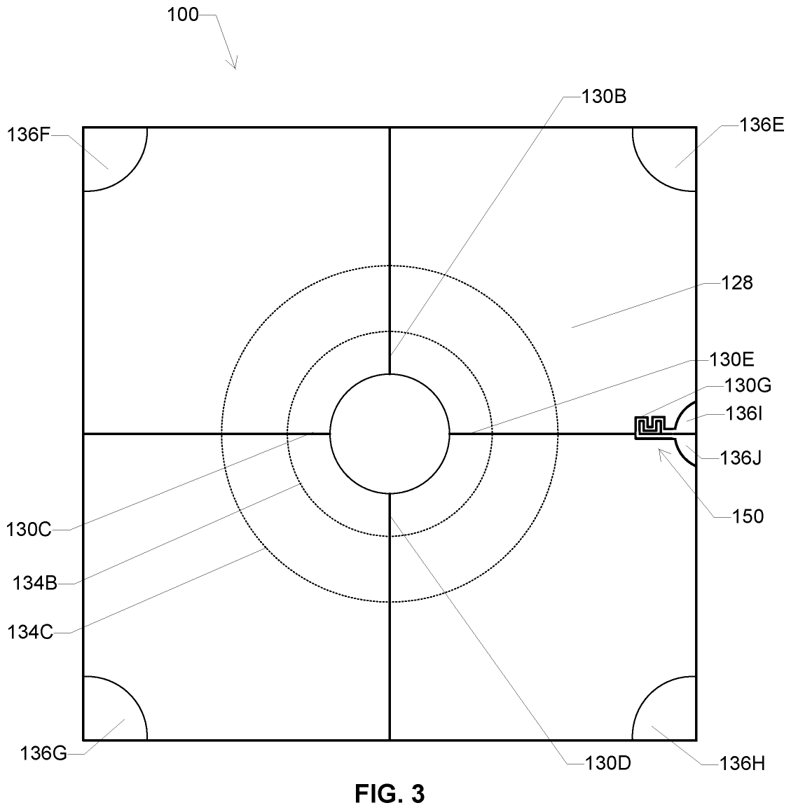

FIG. 2 is a schematic front view of liquid lens 100 looking through first outer layer 118, and FIG. 3 is a schematic rear view of the liquid lens looking through second outer layer 122. For clarity in FIGS. 2 and 3, and with some exceptions, bonds generally are shown in dashed lines, scribes generally are shown in heavier lines, and other features generally are shown in lighter lines.

In some embodiments, common electrode 124 is defined between scribe 130A and bond 134A, and a portion of the common electrode is uncovered by insulating layer 132 such that the common electrode can be in electrical communication with first liquid 106 as described herein. In some embodiments, bond 134A is configured such that electrical continuity is maintained between the portion of conductive layer 128 inside the bond (e.g., inside cavity 104) and the portion of the conductive layer outside the bond. In some embodiments, liquid lens 100 comprises one or more cutouts 136 in first outer layer 118. For example, in the embodiments shown in FIG. 2, liquid lens 100 comprises a first cutout 136A, a second cutout 136B, a third cutout 136C, and a fourth cutout 136D. In some embodiments, cutouts 136 comprise portions of liquid lens 100 at which first outer layer 118 is removed to expose conductive layer 128. Thus, one or more of cutouts 136 (e.g., cutouts 136B and 136C) can enable electrical connection to common electrode 124, and the regions of conductive layer 128 exposed at cutouts 136 can serve as contacts to enable electrical connection of liquid lens 100 to a controller, a driver, or another component of a lens or camera system.

Although cutouts 136 are described herein as being positioned at corners of liquid lens 100, other embodiments are included in this disclosure. For example, in some embodiments, one or more of the cutouts are disposed inboard of the outer perimeter of the liquid lens.

In some embodiments, driving electrode 126 comprises a plurality of driving electrode segments. For example, in the embodiments shown in FIGS. 2 and 3, driving electrode 126 comprises a first driving electrode segment 126A, a second driving electrode segment 126B, a third driving electrode segment 126C, and a fourth driving electrode segment 126D. In some embodiments, the driving electrode segments are distributed substantially uniformly about the sidewall of cavity 104. For example, each driving electrode segment occupies about one quarter, or one quadrant, of the sidewall of second portion 104B of cavity 104. In some embodiments, adjacent driving electrode segments are isolated from each other by a scribe. For example, first driving electrode segment 126A and second driving electrode segment 126B are isolated from each other by a scribe 130B. Additionally, or alternatively, second driving electrode segment 126B and third driving electrode segment 126C are isolated from each other by a scribe 130C. Additionally, or alternatively, third driving electrode segment 126C and fourth driving electrode segment 126D are isolated from each other by a scribe 130D. Additionally, or alternatively, fourth driving electrode segment 126D and first driving electrode segment 126A are isolated from each other by a scribe 130E. The various scribes 130 can be configured as described herein in reference to scribe 130A. In some embodiments, the scribes between the various electrode segments extend beyond cavity 104 and onto the back side of liquid lens 100 as shown in FIG. 3. Such a configuration can ensure electrical isolation of the adjacent driving electrode segments from each other. Additionally, or alternatively, such a configuration can enable each driving electrode segment to have a corresponding contact for electrical connection as described herein.

Although driving electrode 126 is described herein as being divided into four driving electrode segments, other embodiments are included in this disclosure. In some other embodiments, the driving electrode is divided into two, three, five, six, seven, eight, or more driving electrode segments.

In some embodiments, bond 134B and/or bond 134C are configured such that electrical continuity is maintained between the portion of conductive layer 128 inside the respective bond and the portion of the conductive layer outside the respective bond. In some embodiments, liquid lens 100 comprises one or more cutouts 136 in second outer layer 122. For example, in the embodiments shown in FIG. 3, liquid lens 100 comprises a fifth cutout 136E, a sixth cutout 136F, a seventh cutout 136G, and an eighth cutout 136H. In some embodiments, cutouts 136 comprise portions of liquid lens 100 at which second outer layer 122 is removed to expose conductive layer 128. Thus, cutouts 136 can enable electrical connection to driving electrode 126, and the regions of conductive layer 128 exposed at cutouts 136 can serve as contacts to enable electrical connection of liquid lens 100 to a controller, a driver, or another component of a lens or camera system.

Different driving voltages can be supplied to different driving electrode segments to tilt the interface of the liquid lens (e.g., for OIS functionality). Additionally, or alternatively, the same driving voltage can be supplied to each driving electrode segment to maintain the interface of the liquid lens in a substantially spherical orientation about the optical axis (e.g., for autofocus functionality).

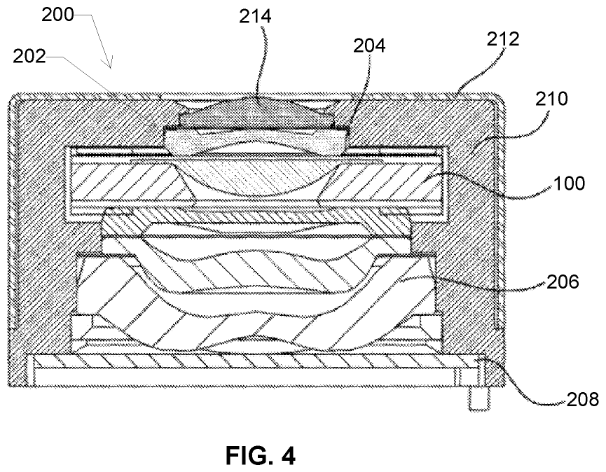

FIG. 4 is a schematic cross-sectional view of some embodiments of a camera module 200. In some embodiments, camera module 200 comprises a lens assembly 202. For example, lens assembly 202 comprises a first lens group 204, liquid lens 100, and a second lens group 206 aligned along an optical axis. Each of first lens group 204 and second lens group 206 can comprise, independently, one or a plurality of lenses (e.g., fixed lenses).

Although lens assembly 202 is described herein as comprising liquid lens 100 disposed between first lens group 204 and second lens group 206, other embodiments are included in this disclosure. In some other embodiments, a lens assembly comprises a single lens group disposed on either side (e.g., the object side or the image side) of liquid lens 100 along the optical axis.

In some embodiments, camera module 200 comprises an image sensor 208. For example, lens assembly 202 is positioned to focus an image on image sensor 208. Image sensor 208 can comprise a semiconductor charge-coupled device (CCD), a complementary metal-oxide-semiconductor (CMOS), an N-type metal-oxide-semiconductor (NMOS), another image sensing device, or a combination thereof. Image sensor 208 can detect image light focused on the image sensor by lens assembly 202 to capture the image represented by the image light. In some embodiments, image sensor 208 can serve as a heating device to transmit heat to liquid lens 100 as described herein.

In some embodiments, camera module 200 comprises a housing 210. For example, lens assembly 202 and/or image sensor 208 are mounted in housing 210 as shown in FIG. 4. Such a configuration can help to maintain proper alignment between lens assembly 202 and image sensor 208. In some embodiments, camera module 200 comprises a cover 212. For example, cover 212 is positioned on housing 210. Cover 212 can help to protect and/or shield lens assembly 202, image sensor 208, and/or housing 210. In some embodiments, camera module 200 comprises a lens cover 214 disposed adjacent lens assembly 202 (e.g., at the object side end of the lens assembly). Lens cover 214 can help to protect lens assembly 202 (e.g., first lens group 204) from scratches or other damage.

In some embodiments, the camera module comprises a heating device. The heating device can be disposed at any suitable position within, on, or near any component of the camera module (e.g., the housing, the lens assembly, the cover, and/or the image sensor) such that the heating device is capable of transmitting thermal energy to the liquid lens and/or generating thermal energy within the liquid lens. For example, the heating device is mounted within the housing (e.g., adjacent the liquid lens) to transmit thermal energy to the liquid lens and/or generate thermal energy within the liquid lens. Additionally, or alternatively, the heating device is incorporated into the liquid lens as described herein. Additionally, or alternatively, the image sensor can be configured to serve as the heating device. For example, power can be applied to the image sensor during a time in which an image is not being captured (e.g., a time when the image sensor generally would be powered off) for transmitting heat generated by the image sensor to the liquid lens. The heating device can comprise a resistive heater, a capacitive heater, an inductive heater, a convective heater, or another type of heater. Additionally, or alternatively, the heating device can transmit thermal energy to the liquid lens through conduction, convection, and/or radiation.

In some embodiments, the camera module comprises a temperature sensor. The temperature sensor can be disposed at any suitable position within, on, or near any component of the camera module (e.g., the housing, the lens assembly, the cover, and/or the image sensor) such that the temperature sensor is capable of detecting a temperature of the camera module or a component thereof (e.g., the liquid lens). For example, the temperature sensor is mounted within the housing (e.g., adjacent the liquid lens) to detect the temperature of the liquid lens. Additionally, or alternatively, the temperature sensor is incorporated into the liquid lens as described herein. The temperature sensor can comprise a thermocouple, a resistive temperature device (RTD), a thermistor, an infrared sensor, a bimetallic device, a thermometer, a change of state sensor, a semiconductor-based sensor (e.g., a silicon diode), or another type of temperature sensing device.

In some embodiments, the heating device is controlled in response to a temperature signal generated by the temperature sensor. For example, the temperature sensor detects the temperature within the camera module and generates the temperature signal that is indicative of the detected temperature. The heating device can be adjusted (e.g., to increase or decrease the amount of heat being transmitted to the liquid lens) based on the temperature signal.

In some embodiments, the heating device is disposed within the liquid lens. For example, in the embodiments shown in FIG. 2, liquid lens 100 comprises a heating device 140. In some embodiments, heating device 140 comprises a portion of conductive layer 128. For example, heating device 140 comprises a portion of conductive layer 128 at least partially defined by a scribe 130F. In some embodiments, heating device 140 at least partially circumscribes cavity 104. For example, heating device 140 comprises a base portion 140A and a ring portion 140B that partially circumscribes cavity 104. Such a configuration can help to enable uniform heating of first liquid 106 and/or second liquid 108.

In some embodiments, ring portion 140B comprises a partial ring having a break therein. Thus, ring portion 140B partially circumscribes cavity 104 without entirely circumscribing the cavity. The break can enable electrical continuity over at least a segment of the remaining portion of conductive layer 128. For example, the break can enable electrical continuity over a segment of conductive layer 128 corresponding to common electrode 124.

In some embodiments, heating device 140 is exposed at at least one cutout 136. For example, in the embodiments shown in FIG. 2, heating device 140 is exposed at two cutouts 136, cutout 136A and cutout 136D. Thus, one or more of cutouts 136 (e.g., cutouts 136A and 136D) can enable electrical connection to heating device 140, and the regions of conductive layer 128 exposed at cutouts 136 can serve as contacts to enable electrical connection of the heating device to a controller, a driver, or another component of a lens or camera system. For example, a current can be passed through heating device 140 by making electrical connection to the heating device at the contacts (e.g., at cutouts 136A and 136D), thereby causing the temperature of the heating device to increase and/or transmit thermal energy to first liquid 106 and/or second liquid 108.

Although heating device 140 is shown in FIG. 2 as being uncovered by insulating layer 132, other embodiments are included in this disclosure. For example, in some other embodiments, the insulating layer covers the heating device or a portion thereof (e.g., a portion of the heating device disposed inside the cavity of the liquid lens). Such a configuration can insulate the heating device from the first liquid and/or the second liquid.

Although heating device 140 is described in reference to FIG. 2 as being disposed within liquid lens 100 and positioned between first outer layer 118 and intermediate layer 120, other embodiments are included in this disclosure. For example, in some other embodiments, the heating device is disposed in the liquid lens and positioned between the intermediate layer and the second outer layer. Additionally, or alternatively, the heating device is disposed on the liquid lens (e.g., on an outer surface or an outer edge of the liquid lens) and/or adjacent to the liquid lens (e.g., within the housing of the camera module).

In some embodiments, the temperature sensor is disposed within the liquid lens. For example, in the embodiments shown in FIG. 3, liquid lens 100 comprises a temperature sensor 150. In some embodiments, temperature sensor 150 comprises a portion of conductive layer 128. For example, temperature sensor 150 comprises a portion of conductive layer 128 at least partially defined by a scribe 130G. In some embodiments, temperature sensor 150 comprises a relatively thin conductive trace having a zig-zag, sawtooth, spiral, undulating, or other suitable pattern.

In some embodiments, temperature sensor 150 is exposed at at least one cutout 136. For example, in the embodiments shown in FIG. 3, temperature sensor 150 is exposed at two cutouts 136, cutout 136I and cutout 136J. Thus, one or more of cutouts 136 (e.g., cutouts 136I and 136J) can enable electrical connection to temperature sensor 150, and the regions of conductive layer 128 exposed at cutouts 136 can serve as contacts to enable electrical connection of the temperature sensor to a controller or another component of a lens or camera system. For example, a current can be passed through temperature sensor 150 by making electrical connection to the temperature sensor at the contacts (e.g., at cutouts 136I and 136J), thereby enabling a detection of the temperature at the temperature sensor (e.g., by measuring resistance).

Although temperature sensor 150 is described in reference to FIG. 3 as being disposed within liquid lens 100 and positioned between and intermediate layer 120 and second outer layer 122, other embodiments are included in this disclosure. For example, in some other embodiments, the temperature sensor is disposed in the liquid lens and positioned between the first outer layer and the intermediate layer. Additionally, or alternatively, the temperature sensor is disposed on the liquid lens (e.g., on an outer surface or an outer edge of the liquid lens) and/or adjacent to the liquid lens (e.g., within the housing of the camera module).

In some embodiments, the heating device and the temperature sensor are positioned opposite each other. Such a configuration can improve the accuracy of the temperature measurement by preventing the temperature sensor from detecting the effects of local heating near the heating device before the thermal energy is transmitted throughout the liquid lens.

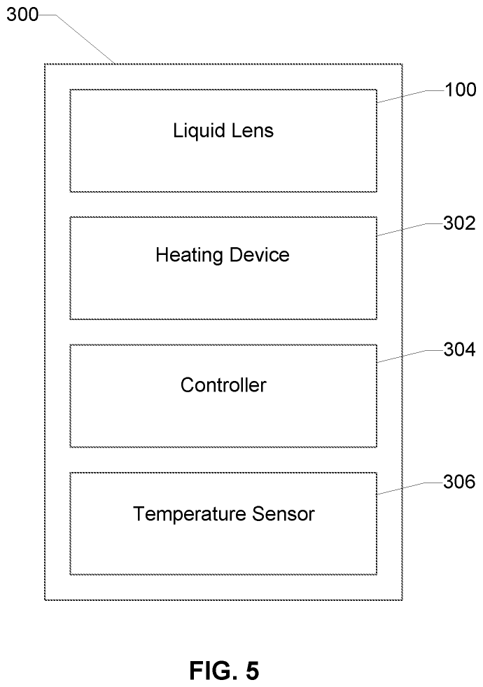

FIG. 5 is a block diagram illustrating some embodiments of a camera module system 300. In some embodiments, camera module system 300 comprises a liquid lens, which can be configured as described herein with regard to liquid lens 100.

In some embodiments, camera module system 300 comprises a heating device 302, which can be configured as described herein with regard to heating device 140. Heating device 302 can be configured to transmit thermal energy to liquid lens 100 and/or generate thermal energy within the liquid lens.

In some embodiments, camera module system 300 comprises a controller 304. Controller 304 can be configured to supply a common voltage to common electrode 124 of liquid lens 100 and a driving voltage to driving electrode 126 of the liquid lens. A shape of interface 110 of liquid lens 100 and/or a position of the interface of the liquid lens can be controlled by the voltage differential between the common voltage and the driving voltage. In some embodiments, the common voltage and/or the driving voltage comprises an oscillating voltage signal (e.g., a square wave, a sine wave, a triangle wave, a sawtooth wave, or another oscillating voltage signal). In some of such embodiments, the voltage differential between the common voltage and the driving voltage comprises a root mean square (RMS) voltage differential. Additionally, or alternatively, the voltage differential between the common voltage and the driving voltage is manipulated using pulse width modulation (e.g., by manipulating a duty cycle of the differential voltage signal).

In various embodiments, controller 304 can comprise one or more of a general processor, a digital signal processor, an application specific integrated circuit, a field programmable gate array, an analog circuit, a digital circuit, a server processor, combinations thereof, or other now known or later developed processor. Controller 304 can implement one or more of various processing strategies, such as multi-processing, multi-tasking, parallel processing, remote processing, centralized processing, or the like. Controller 304 can be responsive to or operable to execute instructions stored as part of software, hardware, integrated circuits, firmware, microcode, or the like.

In some embodiments, camera module system 300 comprises a temperature sensor 306, which can be configured as described herein with regard to temperature sensor 150. Temperature sensor 306 can be configured to detect a temperature within the camera module (e.g., within liquid lens 100) and generate a temperature signal indicative of the detected temperature.

In some embodiments, a method of operating a liquid lens comprises supplying a common voltage to common electrode 124 in electrical communication with first liquid 106 and supplying a driving voltage to driving electrode 126 disposed on a sidewall of cavity 104.

In some embodiments, the method comprises detecting a temperature of the liquid lens. For example, detecting the temperature of the liquid lens comprises detecting the temperature within the liquid lens (e.g., within the cavity and/or between two layers of the liquid lens). Additionally, or alternatively, detecting the temperature of the liquid lens comprises detecting the temperature at an outer surface and/or at a position adjacent to the liquid lens. In some embodiments, detecting the temperature of the liquid lens comprises detecting the temperature of the liquid lens with the temperature sensor. In some embodiments, the method comprises generating a temperature signal indicative of the detected temperature. For example, generating the temperature signal comprises generating the temperature signal with the temperature sensor.

In some embodiments, the method comprises heating the liquid lens (e.g., transmitting thermal energy to the liquid lens and/or generating thermal energy within the liquid lens) in response to the detected temperature (e.g., in response to the temperature signal generated by the temperature sensor). For example, heating the liquid lens comprises generating thermal energy with the heating device. In some embodiments, the method comprises adjusting the heating device in response to the detected temperature. For example, if the detected temperature is below a target temperature, the heating device can be adjusted to transmit more thermal energy to the liquid lens and/or generate more thermal energy within the liquid lens. Additionally, or alternatively, if the detected temperature is above a target temperature, the heating device can be adjusted to transmit less thermal energy to the liquid lens and/or generate less thermal energy within the liquid lens. The heating device can be controlled in response to the detected temperature using a proportional integral (PI) controller, a proportional integral derivative (PID) controller, a fuzzy logic controller, a bang-bang controller, and L squared controller, a predictive controller, or another suitable controller or control strategy.

In some embodiments, the method comprises actuating the liquid lens during the heating. For example, the voltage differential between the common voltage and the driving voltage is manipulated, thereby causing the first liquid and the second liquid to flow within the cavity. In some embodiments, actuating the liquid lens comprises tilting the lens (e.g., tilting the interface between the first liquid and the second liquid relative to the optical axis). For example, tilting the lens comprises tilting the lens back and forth repeatedly in one or more different directions, which can cause the liquids to flow within the cavity. In some embodiments, actuating the liquid lens comprises sequentially tilting the liquid lens in a spiral pattern (e.g., around the plurality of driving electrode segments), which can cause the liquids to swirl within the cavity. Actuating the liquid lens during the heating can help to transmit thermal energy within the liquid lens (e.g., through the liquids), thereby improving thermal uniformity within the liquid lens.

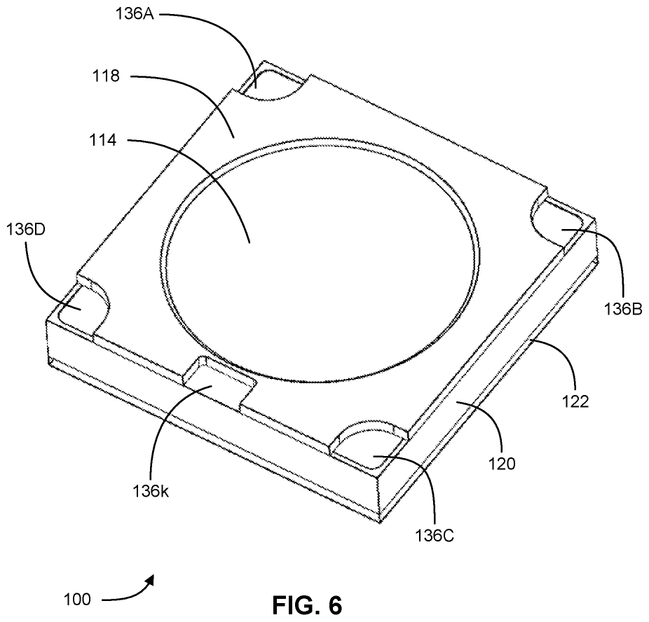

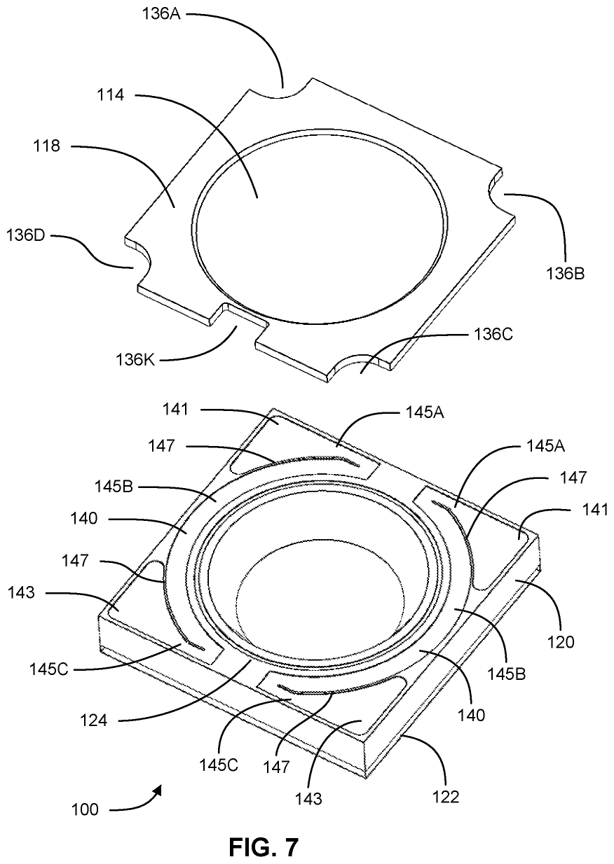

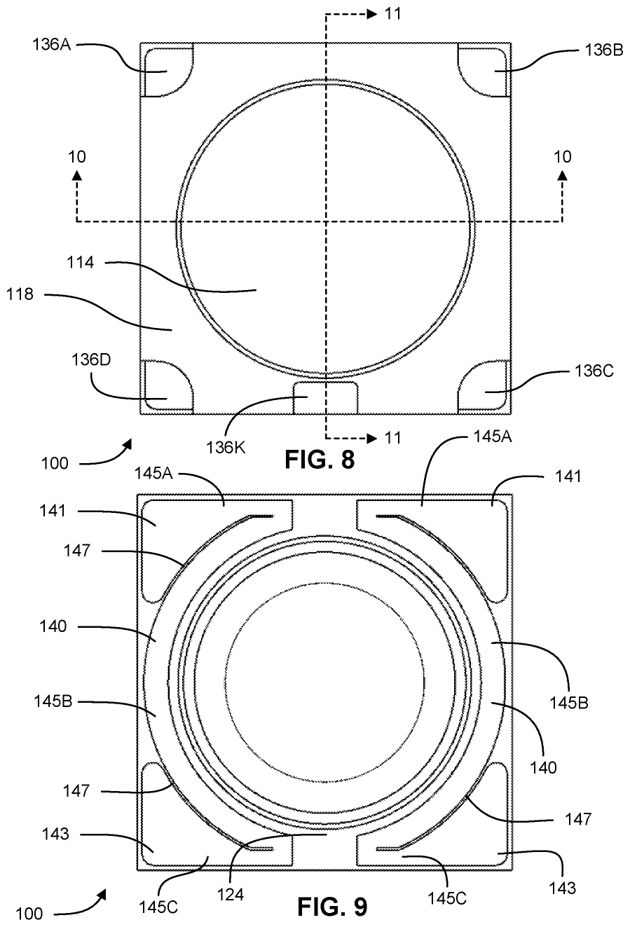

FIG. 6 is a perspective view of example embodiments of a liquid lens 100. FIG. 7 shows an exploded view of the example embodiments of a liquid lens 100 with the first outer layer 118 and/or first window 114 separated to facilitate viewing of the internal components of the liquid lens 100. FIG. 8 is a front view of the example embodiments of a liquid lens 100. FIG. 9 is a front view of the example embodiments of a liquid lens 100 with the first outer layer 118 and/or the first window 114 omitted from view. The example embodiments of FIGS. 6-9 can include features that are similar to, or the same as, the other liquid lens embodiments disclosed herein, many of which are not repeated in connection with FIGS. 6-9.

In some embodiments, the liquid lens 100 can have multiple heating devices 140. For example, a first heating device can be positioned on a first side of the liquid lens 100 (e.g., a left side) and a second heating device can be positioned on a second side of the liquid lens (e.g., a right side). Any suitable number of heating devices 140 can be used, such as one, two, three, four, six, eight, or more heating devices 140. The one or more heating devices 140 can be between the first outer layer 118 and the intermediate layer 120, although other locations are also possible, as discussed herein. The first outer layer 118 and/or the first window 114 can cover the one or more heating devices, in some implementations. Cutouts in the first outer layer 118 can provide access to the one or more heating devices 140, such as for providing electrical current to the heating devices 140. Each heating device 140 can have a first end 141, which can be exposed at a first cutout (e.g., 136A for the left heating device 140) and a second end 143, which can be exposed at a second cutout (e.g., 136D for the left heating device 140). Current can be passed through the heating device 140, such as from the first end 141 to the second end 143, or from the second end 143 to the first end 141. Current can be passed through the heating devices 140 (e.g., on the right and left sides) in the same direction, or in opposite directions. The multiple heating devices 140 can be operated symmetrically, independently, or selectively. In some cases, the system can operate only one heating device 140, or a subset of the heating devices 140, such as for localized heating or for reduced heating. In some cases, substantially the same current can be applied to each of the heating devices 140. In some cases, the system can apply different amounts of current to the different heating devices 140, such as for asymmetrical heating. Current can be driven through the heating devices 140 in the same direction (e.g., from the first end 141 to the second end 143 for both heating devices 140), or in opposite directions (e.g., from the first end 141 to the second end 143 for the first heating device 140, and from the second end 143 to the first end 141 for the second heating device 140).

The heating device 140 can include conductive material that follows a winding path between the first end 141 and the second end 143. The path from the first end 141 to the second end 143 can have an omega shape. The heating device 140 can have a first section 145A that can extend from first end 141 towards the cavity 104. The first section 145 A can extend towards another (e.g., opposing) heating device 140. The heating device 140 can have a second section 145B that extends from the first section 145A and generally follows a path along a periphery of the cavity 104. The heating device 140 can have a third section 145C that extends from the second end 143 to the second section 145B. The third section 145C can extend towards the cavity 104. The third section 145C can extend towards another (e.g., an opposing) heating device 140. The path of the conductive material between the first end 141 and the second end 143 can extend along the first section 145, can turn by about 90 degrees, about 120 degrees, about 150 degrees, about 180 degrees, about 210 degrees, or any values therebetween, or any ranges bounded by these values. The path can extend along the second section 145B, tracking the shape of the outer periphery of the cavity 104, such as along an arcuate or curved path. The path can then turn by an angle of about 90 degrees, about 120 degrees, about 150 degrees, about 180 degrees, about 210 degrees, or any values therebetween, or any ranges bounded by these values and can extend to the second end 143.

In some embodiments, the conductive material of the heating device 140 can turn so that different sections of the heating device 140 are disposed adjacent to each other, such as with an insulating gap 147 therebetween. A gap 147 can be disposed between sections of the heating device 140. For example, a gap 147 can be disposed between the first section 145A and the second section 145B. A gap 147 can be disposed between the second section 145B and the third section 145C. The gap 147 can be electrically insulating. The length of the gap 147 can define a length of the heating device sections that are disposed adjacent each other, and/or can affect the path length of the electrical current through the heating device 140. The shape of the heating device 140 (e.g., the length of the gap 147) can urge the electrical current to flow closer to the cavity 104, and the fluids contained therein, than if the current were to flow along a direct path from the first end 141 to the second end 143 of the heating device 140. Directing the current close to the cavity 104 can facilitate heat transfer to the fluids in the chamber 104. The heating device(s) 140 (e.g., in combination, if multiple heating devices 140 are used) (e.g., the second section(s) 145B thereof) can surround about 270 degrees, about 300 degrees, about 315 degrees, about 330 degrees, about 340 degrees, about 350 degrees, about 355 degrees, of the cavity 104, or any values therebetween, or any ranges bounded by these values, although other configurations are also possible. Adjusting the length of the gap 147 can change the resistance of the heating device 140. For example, a longer flow path (e.g., using a longer gap 147) can have more resistance than a shorter flow path (e.g., using a shorter gap 147). The gap 147 can have a width that this smaller than a width of the heating device 140. The gap(s) 147 between adjacent sections of the heating device(s) 140 can surround about 30 degrees, 60 degrees, 90 degrees, 120 degrees, 150 degrees, or 180 degrees of the cavity periphery, or any values therebetween, or any ranges bounded by these values. Various suitable shapes can be used for the conductive material of the heating devices 140 disclosed herein.

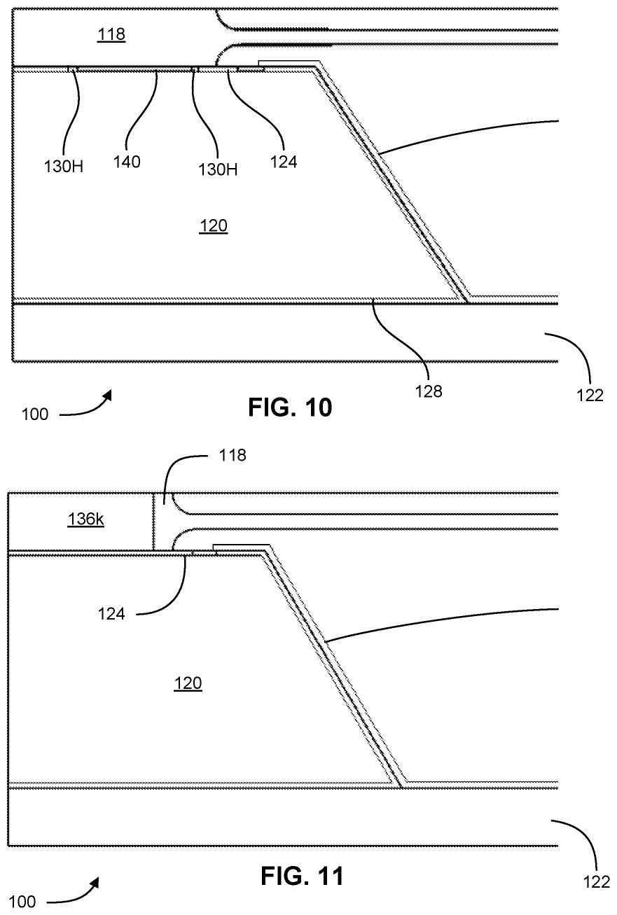

The heating device 140 can be insulated from the common electrode 124. In some embodiments, the heating device 140 can be made of the same material as the common electrode 124 and/or the driving electrode(s) 126. The conductive layer 128 can be used to form the heating device 140. One or more scribes 130H can isolate the heating device 140 from the common electrode 124. Additionally, or alternatively, one or more bonds can isolate the heating device 140 from the common electrode 124. In some embodiments, the bonds can be laser bonds, for example, as described in U.S. Pat. Nos. 9,492,990, 9,515,286, and/or 9,120,287, the entirety of which are incorporated herein by reference. The laser bonds can electrically isolate the heating device 140 (e.g., by diffusing the conductive layer 128 into the adjacent layers (e.g., layers 118, 120, and/or 122) of the liquid lens along the bond path, by ablating the conductive layer 128 along the bond path, or by another suitable mechanism) while also bonding or coupling the adjacent layers of the liquid lens (e.g., layers 118, 120, and/or 122) to each other. For example, in FIG. 9, the lines marking the edges of the heating devices 140 can be scribes and/or bonds that insulate the heating devices 140 from the common electrode 124. FIG. 10 is a partial cross-sectional view of the example embodiments of a liquid lens 100 taken through line 10-10 of FIG. 8. The scribe 130H can be seen in FIG. 10.

In some embodiments, the heating device 140 can include a different conductive material than the common electrode 124. The heating device 140 can include Nichrome or any other suitable conductive material. The material of the heating device 140 can have a higher resistance than the material of the common electrode 124, in some implementations.

The first outer layer 118 can have a cutout 136K for accessing the common electrode 124. FIG. 11 is a partial cross-sectional view of the example embodiment of a liquid lens 100 taken through the line 11-11 of FIG. 8. The heating elements 140 can be spaced apart from each other (e.g., at the cutout 136K) to enable electrical communication to the common electrode 124, which can be in electrical communication with the first fluid 106. In some cases, the gap between the heating elements 140 on the side with the cutout 136K can be larger than the gap between the heating elements 140 on the side without the cutout 136K. In some cases, on the side without the cutout 136K, the heating elements 140 can be adjacent to each other, with a scribe (not shown), a bond, or another insulating later therebetween.

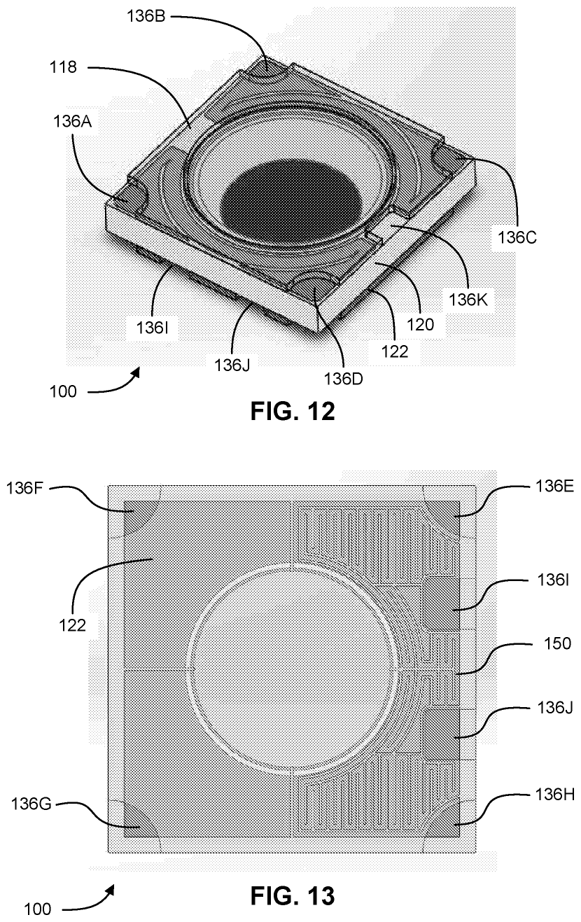

In some embodiments, the liquid lens 100 can use the temperature sensor 150, as disclosed in connection with FIG. 3. Various other temperature sensors can be used, as discussed herein. FIG. 12 is a perspective view of example embodiments of a liquid lens 100. FIG. 13 is a rear view of the liquid lens 100. In FIGS. 12 and 13 the first outer layer 118 and the second outer layer 122 are shown as transparent.

The second outside layer 122 of the liquid lens 100 can have cutouts 136E-H, which can enable electrical communication with the driving electrodes 126. In the illustrated example, the liquid lens 100 includes four driving electrodes 126, although any suitable number of driving electrodes 126 can be used (e.g., 1, 2, 4, 6, 8, 10, 12, 16, or more electrodes, or any values therebetween).

The second outside layer 122 can have cutouts 136I and 136J for providing access to the temperature sensor 150. The temperature sensor 150 can be at least partially disposed between the second outside layer 122 and the intermediate layer 120. An electrical pathway of conductive material for the temperature sensor 150 can extend between the cutouts 136I and 136J. The electrical pathway for the temperature sensor 150 can include 10, 20, 30, 40, 50, 60, 70, 80, 90, 100, 110, 120, or more turns, or any values therebetween, or any ranges bounded by these values, although other designs are also possible. The electrical pathway for the temperature sensor 150 can cover an area that is about 10%, about 15%, about 20%, about 25%, about 30%, about 35%, about 40%, about 45%, about 50%, or more of the footprint area of the liquid lens 100. The electrical pathway for the temperature sensor 150 can surround about 10%, about 15%, about 20%, about 25%, about 30%, about 35%, about 40%, about 45%, about 50%, or more of the periphery of the cavity 104. The electrical pathway for the temperature sensor 150 can overlap areas of the liquid lens 100 corresponding to one or two of the driving electrodes 126. The electrical pathway for the temperature sensor 150 can have a path length that is larger than, about 1.5 times, about 2 times, about 3 times, about 5 times, about 10 times, about 15 times, about 20 times, about 25 times, about 30 times, about 35 times, about 40 times, about 45 times, or about 50 times the width or diameter of the cavity 104 (e.g., at the narrow end 105A or the wide end 1056) and/or the length of a side of the liquid lens 100.

The electrical pathway for the temperature sensor 150 can be made of the same material as the driving electrodes 126, the common electrode 124, and/or the heating device 140. In some cases, the electrical pathway for the temperature sensor 150 can be made of a portion of the conductive layer 128 that is electrically isolated from the driver electrode(s) 126, such as by one or more scribes and/or bonds. In some embodiments, the electrical pathway for the temperature sensor 150 can include a different conductive material than the driver electrode(s) 126. The electrical pathway for the temperature sensor 150 can include titanium, gold, Nichrome, platinum, or various other conductive materials.

In some embodiments, the temperature can be determined based on the resistance of the conductive pathway for the temperature sensor 150. As the fluid is heated, some heat will be transferred to the conductive pathway of the temperature sensor 150, and the heat can cause the resistance of the conductive material to change (e.g., increase). Accordingly, the resistance along the conductive pathway for the temperature sensor 150 can be indicative of the temperature (e.g., of the fluid in the liquid lens). In some cases, the resistance of the conductive pathway for the temperature sensor 150 can be determined, such as using a Wheatstone bridge. For example, a bridge can have one or more reference resistors on a first side of the bridge, and can have a variable resistor and the conductive pathway for the temperature sensor with an unknown resistance on a second side of the bridge. The variable resistor can be adjusted until the two sides of the bridge are balance (e.g., no voltage differential between the two sides of the bridge), and the resistance of the conductive pathway for the temperature sensor 150 can be determined based at least in part on the resistance that was applied to the variable resistor to balance the bridge. The temperature (e.g., of the conductive pathway for the temperature sensor 150) can be determined based on the determined resistance. In some cases, the temperature can be determined directly from the resistance applied to the variable resistor, without the intermediate determination of the resistance of the conductive pathway for the temperature sensor 150. Various other types of temperature sensors can be used, as discussed herein.

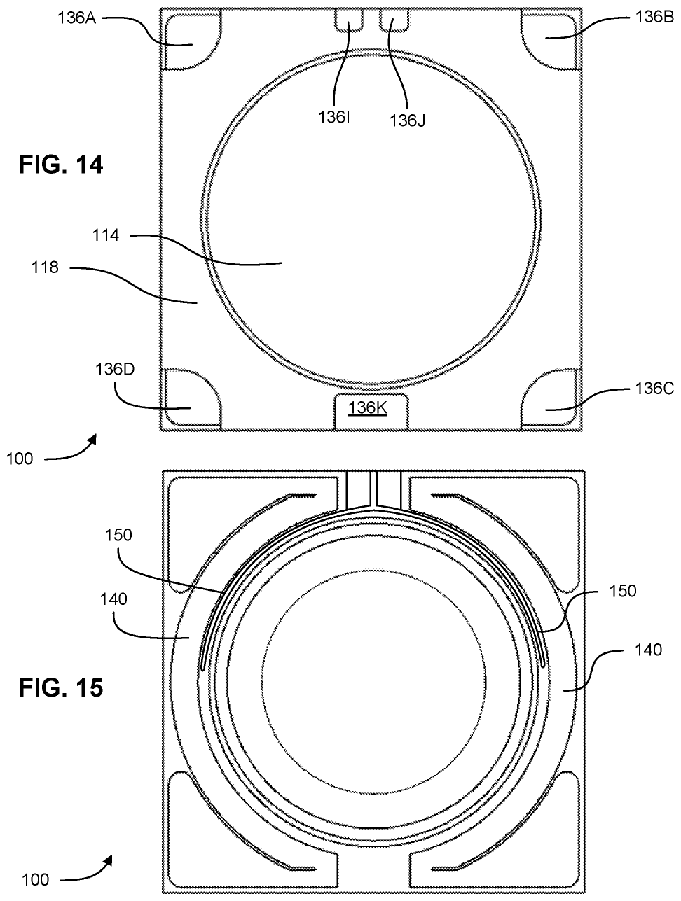

In some embodiments, the temperature sensor 150 can be implemented on a front side of the liquid lens 100. At least a portion of the temperature sensor 150 can be between the first outside layer 118 and the intermediate layer 120. FIG. 14 is an example embodiment of a liquid lens 100, which can have the temperature sensor 150 on a front side thereof. FIG. 15 shows the example embodiment with the first outside layer 118 removed to facilitate viewing the inside of the liquid lens 102. The first outside layer 118 can have cutouts 136I and 136J to provide electrical access to the temperature sensor 150. A conductive pathway can extend between the cutouts 136I and 136J, for example similar to the other embodiments disclosed herein, except that the conductive pathway can be between the first outside layer 118 and the intermediate layer 120. In the illustrated example of FIG. 15, the conductive pathway can extend from the cutout 136I, along a first side (e.g., left side of FIG. 15) of the liquid lens 100, then the conductive pathway can turn back along the first side, transition to extend along a second side (e.g., right side of FIG. 15) of the liquid lens for a distance, and then turn back along the second side to the cutout 136J. In the illustrated embodiment, the conduct pathway of the temperature sensor 150 can surround about half of the cavity 104, although other sizes and patterns are possible.

The cutouts 130 discussed herein are not necessarily created by cutting out material, and any recess or absence of material can be used for the cutouts 130 regardless of how the cutouts 130 were formed. For example, the cutouts 130 can be formed in the first outer layer 118 and/or the second outer layer 122 prior to bonding the respective layer to the intermediate layer 120.

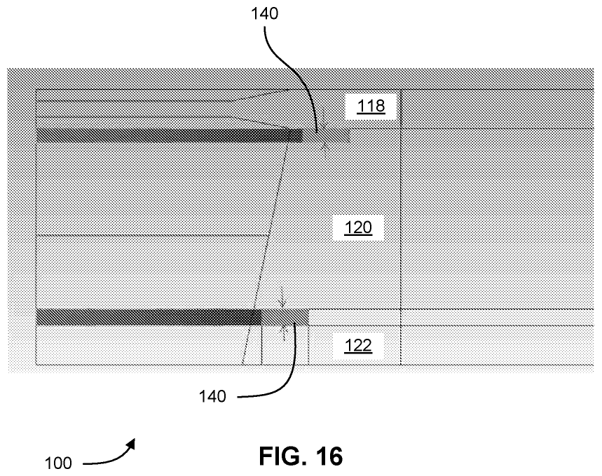

With reference to FIG. 16, in some embodiments, the liquid lens 100 can have a first one or more heaters 140 on a front of the liquid lens 100, such as between the first outer layer 118 and the intermediate layer 120, and a second one or more heaters 150 on the back of the liquid lens 100, such as between the second outer layer 122 and the intermediate layer 120. This can facilitate more uniform distribution of the applied heat to the fluids, and can enable the system to apply more heat than if fewer heating devices 140 were used.

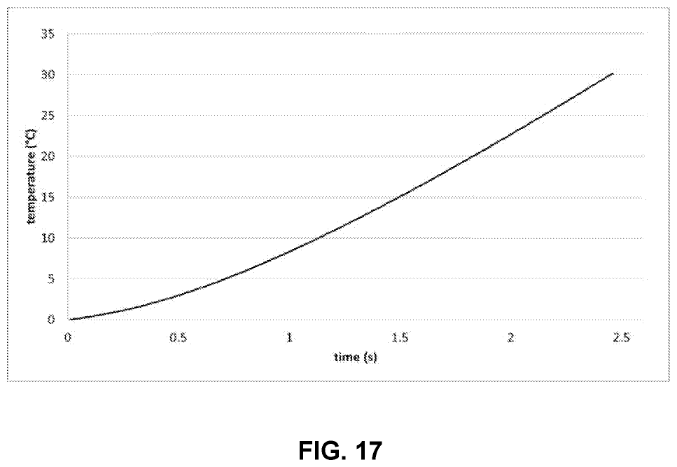

FIG. 17 is a plot showing the increase in temperature from 0 degrees Celsius to 30 degrees Celsius by applying 400 mW using a heater between the first outside layer 118 and the intermediate layer 120. In this example, it took about 2.5 seconds for the heating device 140 to heat the fluid of the liquid lens 100 from 0 degrees Celsius to 30 degrees Celsius.

Various embodiments and features disclosed herein can be used in combination with the embodiments and features that are disclosed in U.S. Provisional Patent Application No. 62/645,641, filed Mar. 20, 2018, and titled Self-Heating Liquid Lens and Self-Heating Methods for the Same (the '641 patent application), which is incorporated herein by reference in its entirety. The features disclosed in the '641 patent application can be used with the embodiments disclosed in the present application. Similarly, the features disclosed in the present application can be applied to the embodiments of the '641 patent application.

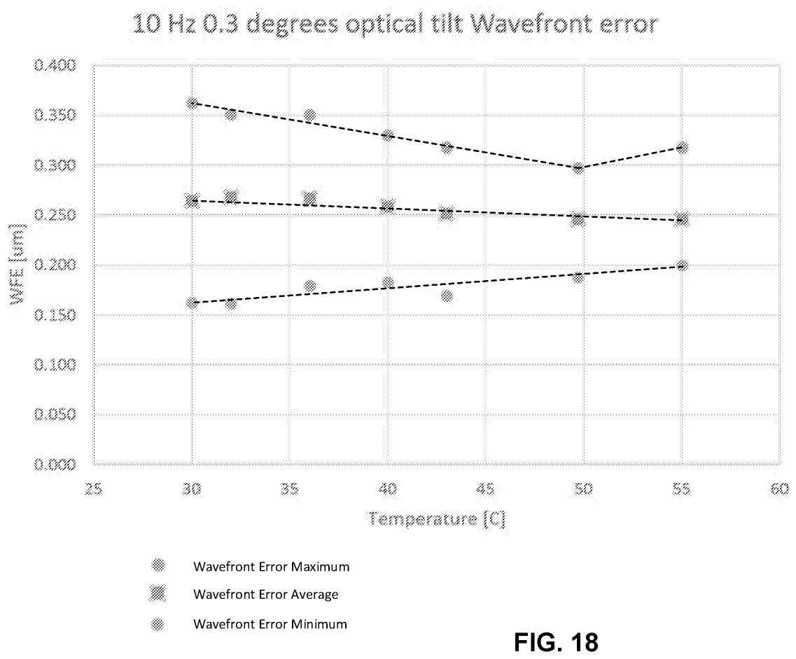

In some embodiments, heating the liquid lens can reduce optical aberrations and/or wavefront error. FIG. 18 is a plot showing wavefront error measurements taken for an example embodiment of a liquid lens in which the fluid interface is oscillated (e.g., by a cosine wave) at a frequency of 10 Hz, with an optical tilt of about 0.3 degrees. For a single period of oscillation, the minimum wavefront error, the average wavefront error, and the maximum wavefront error were measured. The measurements were taken at various temperatures for the liquid lens between 30 degrees C. and 55 degrees C. As can be seen in FIG. 18, the average wavefront error was reduced as the temperature increased from 30 degrees C. to 55 degrees C.

Without being bound or limited by theory, it is believed that the maximum wavefront error for the period is heavily influenced by coma optical aberration that can peak when the angular velocity of the tilting fluid interface is at the highest, which can occur as the fluid interface crosses the untilted position, in some cases. The side of the fluid interface that is moving downward can have an upward bulge, and the side of the fluid interface that is moving upward can have a downward bulge. The bulges can result from the fluid interface “pumping” the fluid laterally across the liquid lens. The bulging of the fluid interface as it moves can produce a dynamic wavefront error (e.g., coma). It is believed that the minimum wavefront error occurs when relatively little coma optical aberration is produced, which can occur when the fluid interface angular velocity is at the slowest. As the fluid interface approaches the peak tilt amplitude (e.g., to produce 0.3 degrees of optical tilt in this example) the movement of the fluid interface can slow down until the motion of the fluid interface changes direction. As the fluid interface slows down, the bulges in the fluid interface shape can be reduced, which can result in less coma aberration, and reduced wavefront error. Accordingly, the difference between the minimum wavefront error and the maximum wavefront error can correlate to the amount of coma optical aberration, in this example. Other optical aberrations, such as trefoil, can be present, and can vary based on the position of the fluid interface, accordingly, the difference between the maximum and minimum wavefront errors may not correspond directly or perfectly to the amount of coma optical aberration, but a general correlation is believed to exist between the amount of coma optical aberration and the difference between the maximum and minimum wavefront errors in the example of FIG. 18. In some cases, dynamic wavefront error (e.g., resulting from the motion of the fluid interface) can be at a maximum when the fluid interface is moving most rapidly, and the dynamic wavefront error can be at a minimum when the fluid interface is stopped or the motion is slowest. Accordingly, the difference between the maximum total wavefront error and the minimum total wavefront error can be indicative, in some cases, of how much of the wavefront error is attributable to the dynamic wavefront error (which can include coma, for example).

As can be seen in FIG. 18, the amount of coma optical aberration can be reduced as the temperature of the liquid lens is increased, such as using a heater, as disclosed herein. At 30 degrees C., the difference between the maximum and minimum wavefront errors is about 200 nm. At 32 degrees C. the difference between the maximum and minimum wavefront errors is about 190 nm. At 36 degrees C. the difference between the maximum and minimum wavefront errors is about 172 nm. At 40 degrees C. the difference between the maximum and minimum wavefront errors is about 147 nm. At 43 degrees C. the difference between the maximum and minimum wavefront errors is about 149 nm. At 49.7 degrees C. the difference between the maximum and minimum wavefront errors is about 110 nm. At 55 degrees C. the difference between the maximum and minimum wavefront errors is about 118 nm. At 32 degrees C. the difference between the maximum and minimum wavefront errors is about 190 nm. Accordingly, as the temperature of the liquid lens was increased from 30 degrees C. to 50 degrees C., the dynamic wavefront error (e.g., coma) decreased by about 45%. The average wavefront error was reduced from about 265 nm to about 245 nm when the temperature was increased from 30 degrees C. to 55 degrees C. The maximum wavefront error was decreased from about 363 nm to about 297 nm when the temperature was increased from 30 degrees C. to 50 degrees C.

FIG. 18 shows that increasing the temperature from 50 degrees C. to 55 degrees C. caused the total wavefront error to increase. Without being bound or limited by theory, it is believed that increasing the temperature beyond a threshold amount can cause the viscosity of the fluids to be reduced to the point that the fluid interface overshoots the target location. The threshold temperature can depend on the properties of the fluids used.

The heater can be used to raise the temperature of the liquid lens to a temperature or range of temperatures, such as using a feedback control system and a temperature sensor. The heater can raise the temperature to about 30 degrees C., about 32 degrees C., about 34 degrees C., about 34 degrees C., about 36 degrees C., about 38 degrees C., about 40 degrees C., about 42 degrees C., about 44 degrees C., about 46 degrees C., about 48 degrees C., about 50 degrees C., about 52 degrees C., about 54 degrees C., about 56 degrees C., about 58 degrees C., about 60 degrees C., or any values therebetween, or any ranges bounded by any combination of these values.

The temperature can also affect (e.g., reduce) the static wavefront error (e.g., optical aberrations that are produced by the driven shape of the fluid interface without motion of the fluid interface). The static wavefront error can include trefoil in some embodiments.

In some embodiments, using additional driving electrodes can reduce the static wavefront error (e.g., including trefoil). For example, additional driving electrodes can provide more control over the fluid interface, and can result is smaller voltage steps between adjacent electrodes, which can reduce the wavefront error. For example, by using 8 driving electrodes, a liquid lens can be made having trefoil wavefront error of about 10 nm, about 12 nm, about 15 nm, about 20 nm, about 25 nm, about 30 nm or less, or any values therebetween, or any ranges bounded by any combination of these values. By heating the liquid lens, the dynamic wavefront error (e.g., coma) can be plus or minus about 30 nm, about 35 nm, about 40 nm, about 45 nm, about 50 nm, about 55 nm, about 60 nm, about 65 nm, about 70 nm or any values therebetween, or any ranges bounded by any combination of these values.

In some embodiments, a liquid lens system comprises a liquid lens and a heating device disposed in, on, or near the liquid lens. The liquid lens system can comprise a temperature sensor, wherein the heating device is responsive to a temperature signal generated by the temperature sensor in, on, or near the liquid lens. Additionally, or alternatively, the liquid lens can comprise a cavity, a first liquid and a second liquid disposed within the cavity, the first liquid and the second liquid substantially immiscible with each other and having different refractive indices such that an interface between the first liquid and the second liquid defines a variable lens, a common electrode in electrical communication with the first liquid, and a driving electrode disposed on a sidewall of the cavity and insulated from the first liquid and the second liquid. Additionally, or alternatively, the heating device is disposed in the liquid lens. For example, the heating device is disposed between a first outer layer of the liquid lens and an intermediate layer of the liquid lens. For example, the liquid lens comprises a conductive layer, wherein a first portion of the conductive layer defines the common electrode, and a second portion of the conductive layer defines the heating device. Additionally, or alternatively, the heating device at least partially circumscribes the cavity of the liquid lens. Additionally, or alternatively, the liquid lens system comprises a temperature sensor, wherein the heating device comprises an image sensor that is responsive to a temperature signal generated by the temperature sensor. In some embodiments, a camera module comprises the liquid lens system.

In some embodiments, a method of operating a liquid lens comprises detecting a temperature of the liquid lens and heating the liquid lens in response to the detected temperature. Additionally, or alternatively, the detecting the temperature of the liquid lens comprises detecting the temperature within the liquid lens. Additionally, or alternatively, the detecting the temperature of the liquid lens comprises detecting the temperature at an outer surface of the liquid lens. Additionally, or alternatively, the heating the liquid lens comprises heating a liquid disposed within a cavity of the liquid lens. Additionally, or alternatively, the heating the liquid lens comprises generating thermal energy with a heating device disposed within the liquid lens. Additionally, or alternatively, the heating the liquid lens comprises generating thermal energy with a heating device disposed on or adjacent the liquid lens and transmitting the thermal energy to the liquid lens. Additionally, or alternatively, the method comprises actuating the liquid lens during the heating the liquid lens. For example, the actuating the liquid lens comprises repeatedly tilting the liquid lens, thereby causing a liquid disposed within a cavity of the liquid lens to flow within the cavity.

It will be apparent to those skilled in the art that various modifications and variations can be made without departing from the spirit or scope of the claimed subject matter. Accordingly, the claimed subject matter is not to be restricted except in light of the attached claims and their equivalents. Other embodiments and combinations are contemplated, which are not specifically set forth in the claims.

1. A liquid lens system comprising:
a liquid lens comprising a conductive layer; and
a heating device disposed in the liquid lens;
wherein the heating device is disposed (1) between a first outer layer of the liquid lens and an intermediate layer of the liquid lens or (2) between a second outer layer of the liquid lens and the intermediate layer of the liquid lens; and
wherein a first portion of the conductive layer defines one of a common electrode or a driving electrode, and a second portion of the conductive layer defines the heating device.

2. The liquid lens system of claim 1, wherein the heating device is responsive to a temperature signal generated by a temperature sensor disposed in, on, or near the liquid lens.

3. The liquid lens system of claim 1, the liquid lens comprising:
a cavity;
a first liquid and a second liquid disposed within the cavity, the first liquid and the second liquid having different refractive indices such that an interface between the first liquid and the second liquid defines a variable lens;
the common electrode in electrical communication with the first liquid; and
the driving electrode disposed on a sidewall of the cavity and insulated from the first liquid and the second liquid.

4-7. (canceled)

8. The liquid lens system of claim 1, wherein the one of the common electrode or the driving electrode and the heating device are separated from each other by (1) a scribe or (2) a bond.

9. The liquid lens system of claim 1, wherein the heating device at least partially circumscribes a cavity of the liquid lens.

10. The liquid lens system of claim 9, wherein the heating device comprises a first section extending toward the cavity of the liquid lens and a second section extending from the first section along a periphery of the cavity.

11. The liquid lens system of claim 10, wherein a width of a gap between the first section of the heating device and the second section of the heating device is smaller than a width of the heating device.

12. The liquid lens system of claim 10, wherein a gap between the first section of the heating device and the second section of the heating device surrounds about 30 degrees to about 180 degrees of the periphery of the cavity.

13. The liquid lens system of claim 9, wherein the heating device comprises a first heating device and a second heating device disposed on opposing sides of the cavity of the liquid lens.

14. The liquid lens system of claim 1, comprising a temperature sensor disposed in the liquid lens.

15. The liquid lens system of claim 14, the liquid lens comprising:
a cavity;
a first liquid and a second liquid disposed within the cavity, the first liquid and the second liquid having different refractive indices such that an interface between the first liquid and the second liquid defines a variable lens;
the common electrode in electrical communication with the first liquid; and
the driving electrode disposed on a sidewall of the cavity and insulated from the first liquid and the second liquid;
wherein the first portion of the conductive layer defines the one of the common electrode or the driving electrode;
wherein the second portion of the conductive layer defines the heating device; and
wherein a third portion of the conductive layer defines the temperature sensor.

16. The liquid lens system of claim 15, wherein the temperature sensor comprises an electrical pathway that covers at least about 10% of a footprint area of the liquid lens.

17. (canceled)

18. A liquid lens system comprising:
a liquid lens comprising:
a cavity;
a first liquid and a second liquid disposed within the cavity, the first liquid and the second liquid having different refractive indices such that an interface between the first liquid and the second liquid defines a variable lens;
a common electrode in electrical communication with the first liquid; and
a driving electrode disposed on a sidewall of the cavity and insulated from the first liquid and the second liquid;
a heating device separated from one of the common electrode or the driving electrode by (1) a scribe or (2) a bond; and
a temperature sensor separated from one of the common electrode or the driving electrode by (1) a scribe or (2) a bond.

19. The liquid lens system of claim 18, wherein:
the heating device is disposed (1) between a first outer layer of the liquid lens and an intermediate layer of the liquid lens or (2) between a second outer layer of the liquid lens and the intermediate layer of the liquid lens; and
the temperature sensor is disposed (1) between the first outer layer of the liquid lens and the intermediate layer of the liquid lens or (2) between the second outer layer of the liquid lens and the intermediate layer of the liquid lens.

20. The liquid lens system of claim 19, wherein the heating device surrounds about 30 degrees to about 180 degrees of a periphery of the cavity.

21. The liquid lens system of claim 19, wherein the temperature sensor comprises an electrical pathway that covers at least about 10% of a footprint area of the liquid lens.

22. The liquid lens system of claim 18, wherein the common electrode, the driving electrode, the heating device, and the temperature sensor are discrete portions of a common conductive layer of the liquid lens.

23. A camera module comprising the liquid lens system of claim 1.

24. A method of operating a liquid lens, the method comprising:
detecting a temperature of the liquid lens;
heating the liquid lens in response to the detected temperature; and
actuating the liquid lens during the heating by repeatedly tilting a variable interface of the liquid lens, thereby causing a liquid disposed within a cavity of the liquid lens to flow within the cavity.

25-26. (canceled)

27. The method of claim 24, wherein:
the heating the liquid lens comprises generating thermal energy with a heating device disposed within the liquid lens;
a common electrode, a driving electrode, and the heating device are discrete portions of a common conductive layer of the liquid lens; and
the heating device is separated from one of the common electrode or the driving electrode by (1) a scribe or (2) a bond.

28-30. (canceled)
